(19) United States
(12) Patent Application Publication
(10) Pub. No.: US 2006/0043254 A1
(43) Pub. Date: Mar. 2, 2006

(54) Anti-viibration system

(75) Inventors: Bang-Ji Wang, Taipei City (TW); Chang-Chien Li, Taipei County (TW); Chun-Chieh Liao, Taoyuan City (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/195,681

(22) Filed: Aug. 3, 2005

(30) Foreign Application Priority Data
Aug. 30, 2004 (TW) 93213736

(51) Int. Cl. G01P 21/00

(52) U.S. Cl. 248/550

(57) ABSTRACT

An anti-vibration system for an electronic device. A sensor detects vibration of the electronic device and converts the vibration to an electrical signal, and a controller connected to the sensor receives the electrical signal and transmits a control signal. An anti-vibration device is connected to the controller and activated by the control signal to cancel the vibration.

### BACKGROUND

The invention relates to an anti-vibration system for an electronic device.

In electronic devices such as projectors, optical drives and the like, noise can be generated by vibration. For example, high speed rotation (7200 rpm to 900 rpm) of a color wheel vibrates housings thereof, and rotation of a fan causes vibration. In typical anti-vibration measures, rubber, cast iron or soft plastic pads are employed to cancel the vibration, but provide only limited effect. Thus, an electronic anti-vibration method is desirable to more effectively counteract vibration and thus reduce noise. Material fatigue from extended periods of vibration is also a concern, for example damage to color wheels can be caused by vibration. An active electronic anti-vibration system can resolve the mentioned problems and reduce maintenance cost.

### SUMMARY

Accordingly, an anti-vibration system for an electronic device according to embodiments of the invention comprises a sensor detecting vibration of the electronic device and converting the vibration to an electrical signal, a controller connected to the sensor, receiving the electrical signal and transmitting a control signal, and an anti-vibration device connected to the controller and activated by the control signal to reduce the vibration.

### BRIEF DESCRIPTION OF THE DRAWINGS

The invention can be more fully understood by reading the subsequent detailed description and examples with references made to the accompanying drawings, wherein:

FIG. 1a is block diagram of an active anti-vibration system according to embodiments of the invention;

FIG. 1b is a circuit diagram of a controller according embodiments of the invention;

FIG. 2 is a perspective view of an anti-vibration device according to embodiments of the invention;

FIG. 3 is a schematic view of a sensor according to embodiments of the invention;

FIG. 4 is a schematic view of an anti-vibration device according to an embodiment of the invention;

FIG. 5 is a schematic view of another anti-vibration device according to embodiments of the invention; and

FIG. 6 is a schematic view of yet another anti-vibration device according to embodiments of the invention.

### DETAILED DESCRIPTION

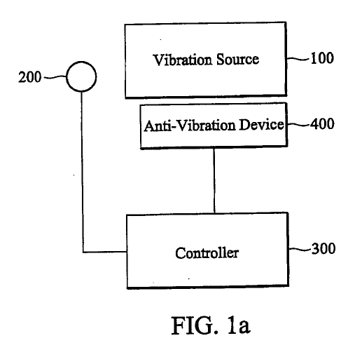

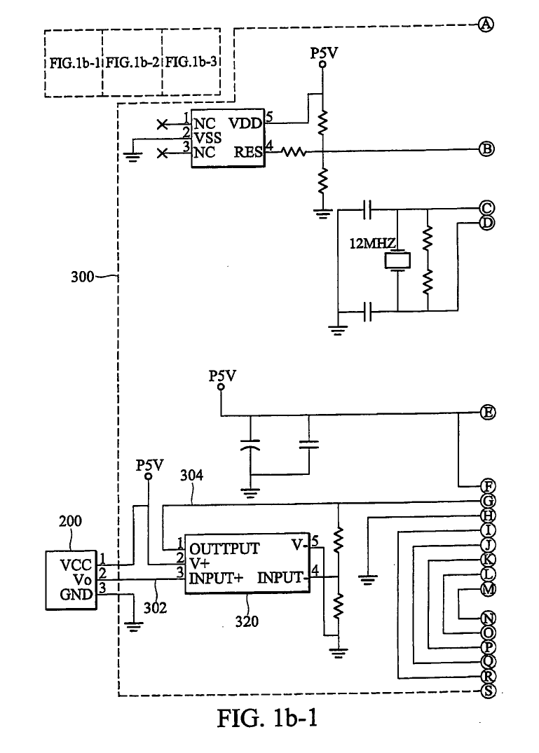

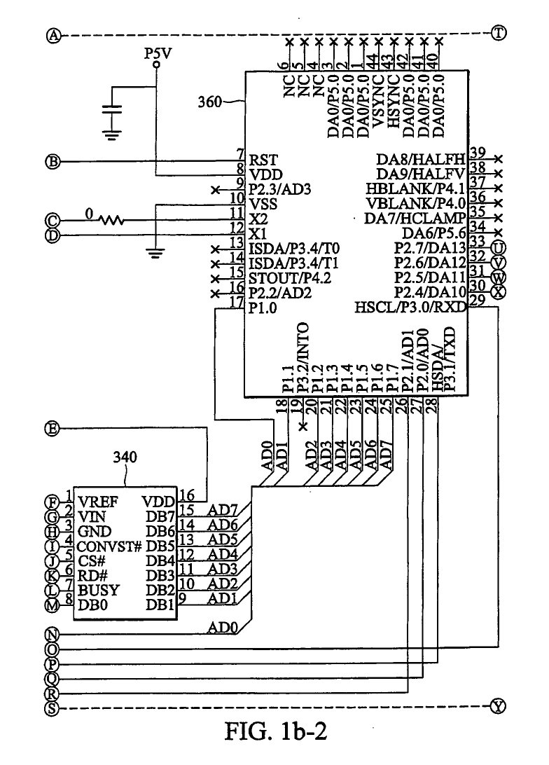

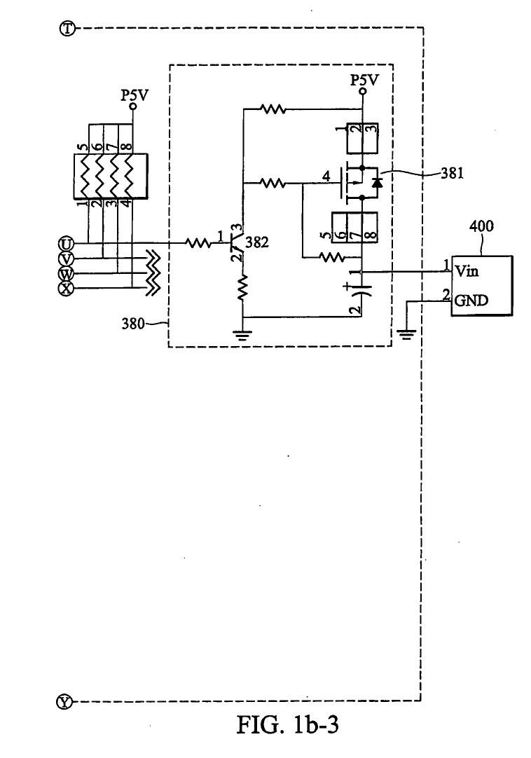

An anti-vibration system according to an embodiment of the invention as shown in FIG. 1a reduces vibration of an electronic device such as, for example, an optical drive. A sensor 200 detects vibration from source 100, such as a rotatable element of a projector or an optical drive, and converts the vibration to an electrical signal, whereby the anti-vibration system of the embodiment can be applied to a damper on a motor. A controller 300 comprising a central processing unit receives and processes the electrical signal from the sensor 200 with an appropriate algorithm to create a control signal. An anti-vibration device 400 is activated by the control signal from the controller 300 to reduce vibration of the source 100.

FIG. 1b is a circuit diagram of the controller 300, wherein sensor 200 converts vibration to a voltage signal 302 for output to an operational amplifier 320. The operational amplifier 320 receives the voltage signal 302 and outputs an amplified voltage signal 304 to an analog/digital converter 340 in which the analog voltage signal 304 is converted into a digital signal of 8 bits including signals AD0 to AD7. While digital signal in this embodiment has 8 bits, it is not limited thereto. The digital signal (Ad0 to AD7) is input to a CPU (central processing unit) 360 and processed therein. A PWM (pulse width modulation) signal PWM1 is output from the CPU 360 to an anti-vibration device driver 380 comprising a first transistor 381 and a second transistor 382. The PWM signal PWM1 switches the second transistor 382 on and off (When the PWM signal PWM1 is at high level, the second transistor 382 is on, and when at low level, the second transistor 382 is off), and the second transistor 382 switches the first transistor 381 on or off (when the second transistor 382 is on, the first transistor 381 is on) to activate the anti-vibration device 400.

The operational amplifier 320 provides gain adjustment to optimize the output voltage range of the sensor 200 to optimize the efficiency of the analog/digital converter 340. For example, if the output voltage range is from 0 to 1V and the input voltage range of the analog/digital converter 340 from 0 to 5V, the gain is adjusted to 5 to obtain optimum efficiency.

The analog/digital converter 340 converts the voltage signal 304 into a digital signal of 8 bits. Precision of the digital signal increases with bit count. For example, a digital signal of 8 bits provides resolution of 256 (28) levels, and 10 bits a resolution of 1024 (2¹⁰) levels.

The CPU 360 multiplies the digital signal (AD0 to AD7) by a function f(x), a matching function of the anti-vibration device 400. The matching function can be linear or non-linear depending on the anti-vibration device 400. The CPU 360 outputs a square wave signal, PWM signal, to control the on/off period of the second transistor 382 for the anti-vibration device driver 380.

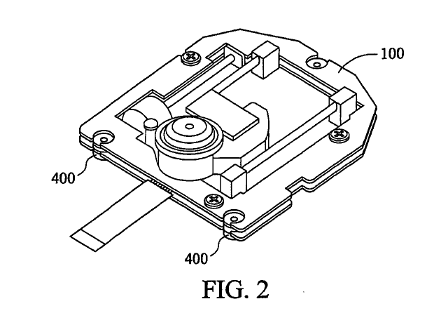

Referring to FIG. 2, the anti-vibration device 400 disposed between the source 100 and a substrate reduces vibration thereof.

The sensor 200 comprises a plurality of strain gauges to detect vibration from multiple directions. As shown in FIG. 3, each strain gauge can detect strain from two directions. Three strain gauges configured triangularly, or separated by 120° to reduce noise signal and increase precision. Each strain gauge is connected to a Wheatstone bridge, converting a voltage measured from the strain gauge to a corresponding resistance value. The strain is calculated with Hook's law to obtain a corresponding stress value employed by the controller 300 to drive the anti-vibration device 400.

The controller 300 can send a PWM signal, in which the width of pulse from the controller 300 is modulated to control action of the anti-vibration device 400 or change the amplitude of the action, or a voltage signal, in which the CPU of the controller 300 controls a digital/analog converter such as chip AD5301 to send a voltage signal to control active amplitude of the anti-vibration device 400.

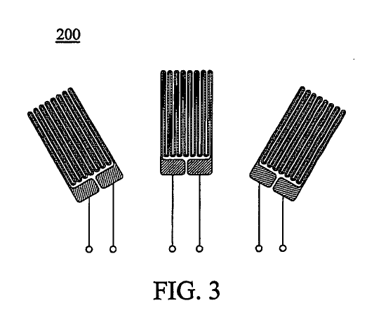

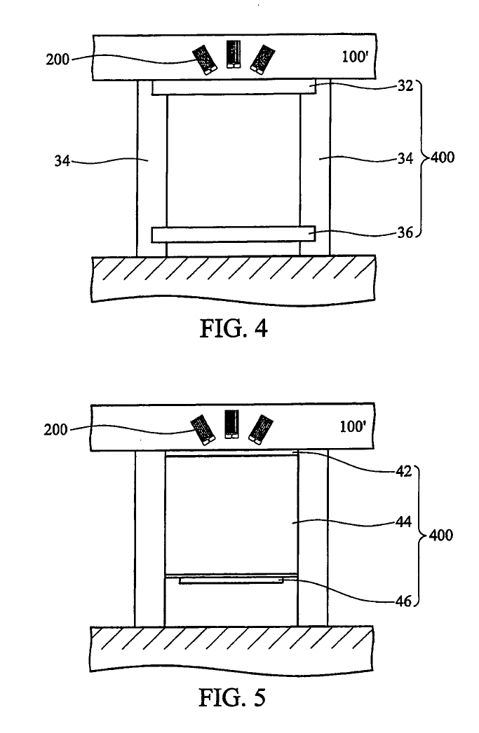

In FIG. 4, an anti-vibration device comprises a permanent magnet 32 contacting a motor assembly 100′ (vibration source 100). An electromagnet 36 is separated from the permanent magnet 32 with a predetermined distance. A rubber wall 34, to which the permanent magnet 32 and the electromagnet 36 are fixed, supports the motor assembly 100′. The electromagnet 36 exerts attractive or repellent force on permanent magnet 32 to reduce vibration of the motor assembly 100′. The sensor 200 is a strain gauge detecting the strain of the motor assembly 100′ caused by the vibration thereof and creating a voltage signal for the controller 300.

In FIG. 5, alternatively, an anti-vibration device 400 comprises an elastic element contacting the motor assembly 100′ and a tank 44 filled with water, air or the like. The elastic element 42 is disposed above the tank 44, and a speaker 46 is disposed therebeneath, capable of oscillating the contents. When vibration of the motor assembly 100′ is transmitted to the contents of tank 44 via the elastic element 42, the speaker 46 oscillates the contents according to the control signal from the controller 300, reducing vibration. The sensor 200 is a strain gauge detecting the strain on the motor assembly 100′ caused by vibration thereof, creating a voltage signal for the controller 300.

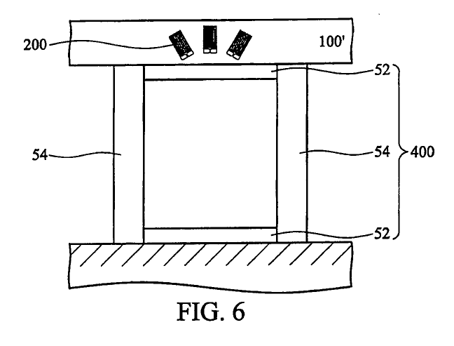

As shown in FIG. 6, alternatively, an anti-vibration device 400 comprises a contact element 52 contacting the motor assembly 100′ and a wall 54 supporting the motor assembly 100′. Vibration of the motor assembly 100′ is transmitted to the wall 54 via the contact element 52. Rigidity of the wall 54 is varied by current passing therethrough corresponding to the control signal from the controller 300, reducing vibration. The sensor 200 is a strain gauge detecting strain on the motor assembly 100′ caused by vibration thereof and creating a voltage signal for the controller 300.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An anti-vibration system for an electronic device, comprising:
a sensor detecting vibration of the electronic device and converting the vibration to an electrical signal;
a controller connected to the sensor, receiving the electrical signal and transmitting a control signal; and
an anti-vibration device connected to the controller and driven by the control signal to control vibration.

2. The anti-vibration system as claimed in claim 1, wherein the controller comprises a central processing unit receiving the electrical signal and processing the electrical signal with an appropriate algorithm.

3. The anti-vibration system as claimed in claim 1, wherein the anti-vibration device comprises:
a permanent magnet contacting the electronic device; and
an electromagnet separated from the permanent magnet and exerting appropriate force thereon corresponding to the control signal, to control vibration of the electronic device.

4. The anti-vibration system as claimed in claim 1, wherein the anti-vibration device comprises:
an elastic element contacting the electronic device;
a fluid contacting the elastic element; and
a vibrator vibrating the fluid corresponding to the control signal to control vibration of the electronic device.

5. The anti-vibration system as claimed in claim 1, wherein the anti-vibration device comprises an anti-vibration element contacting the electronic device, wherein current through the anti-vibration element is varied corresponding to the control signal, to change rigidity of the anti-vibration element, to control vibration of the electronic device.

6. The anti-vibration system as claimed in claim 1, wherein the sensor is a strain gauge detecting strain on the electronic device caused by vibration.
